(19) United States
(12) Patent Application Publication
(10) Pub. No.: US 2009/0268759 A1
(43) Pub. Date: Oct. 29, 2009

(54) SYSTEM AND METHOD FOR DETECTING AND CORRECTING A FALSE EMBEDDED HEADER

(76) Inventors: Ronald Keen, Indianapolis, IN (US); Charles Worrell, Carmel, IN (US)

Correspondence Address: FLETCHER YODER P.C., 7915 FM 1960 RD. WEST, SUITE 330, HOUSTON, TX, 77070, US

(21) Appl. No.: 12/519,516

(22) PCT Filed: Jan. 10, 2007
(86) PCT No.: PCT/US07/00740

§ 371 Date: Jun. 16, 2009

(51) Int. Cl. H04J 3/06

(52) U.S. Cl. 370/503; 375/240.25

(57) ABSTRACT

There is provided a system and method for detecting and correcting a false embedded header. More specifically, in one embodiment, there is provided a method, comprising locating an ancillary data packet in a data stream based on a first sequence of data indicative of the ancillary data packet, determining if the ancillary data packet contains a second sequence of data indicative of sync information, and altering the second sequence of data to not indicate sync information if the ancillary data packet does contain the second sequence of data.

### FIELD OF THE INVENTION

The present invention relates generally to television signal processing. More particularly, the present invention relates to a feature of a media device that detects and corrects a false embedded synchronization header.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

A television may be described as an electronic device that receives television signals and displays the associated visual information on a screen. Watching television is a very popular pastime in the United States and other countries. The transmission of television signals may include converting video information into corresponding electrical signals which are then transmitted through wires or by radio waves to a television which reproduces the original information. Some television signals may include ancillary information such as closed captioning data in addition to audio and video data. The closed captioning data may be hidden in the area of data found in the vertical blanking interval of the television signal. The vertical blanking interval was initially included in television data streams to allow time for the electron gun to return to the upper left corner of the screen to begin painting the next frame.

Because different types of data may be included in a television signal, it is often desirable to communicate what type of data is being transmitted. Accordingly, data headers are often used to indicate what type of data will follow the header. For example, a specific series of hexadecimal values may be reserved as an indication that video data is being transmitted. However, errors can occur when values reserved as headers are included in a stream of data without the intention of acting as a header. Indeed, this improperly included data will generally operate as a false header, which results in improper interpretation of the data and possible malfunction or degraded performance of the receiving media device, such as a television.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

There is provided a system and method for detecting and correcting a false embedded header. More specifically, in one embodiment, there is provided a method, comprising locating an ancillary data packet in a data stream based on a first sequence of data indicative of the ancillary data packet, determining if the ancillary data packet contains a second sequence of data indicative of sync information, and altering the second sequence of data to not indicate sync information if the ancillary data packet does contain the second sequence of data.

### BRIEF DESCRIPTION OF THE DRAWINGS

Advantages of the invention may become apparent upon reading the following detailed description and upon reference to the drawings in which:

FIG. 1 is a block diagram of an electronic system in accordance with an exemplary embodiment of the present invention;

FIG. 2 is a block diagram representing a system for detecting and correcting false headers in accordance with an exemplary embodiment of the present invention;

FIG. 3 is a block diagram of a logic circuit that is adapted to detect and correct false headers in data streams in accordance with an exemplary embodiment of the present invention; and

FIG. 4 is a process flow diagram illustrating a method for detecting and correcting false headers in data streams in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

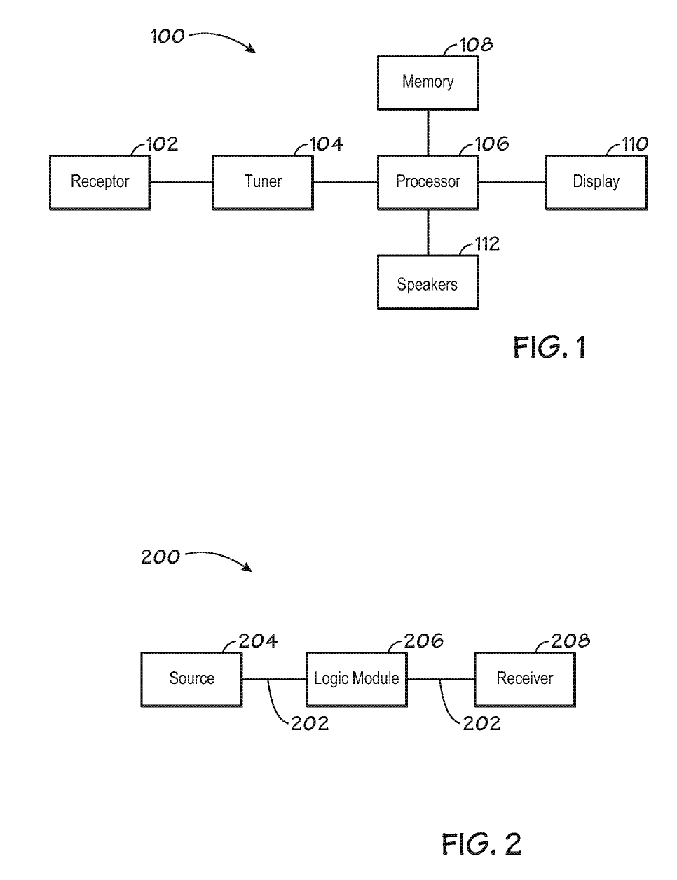

FIG. 1 is a block diagram of an electronic system in accordance with an exemplary embodiment of the present invention. The electronic system is generally indicated by reference numeral 100. Specifically, the electronic system 100 includes a receptor 102, a tuner 104, a processor 106, a memory 108, a display 110, and speakers 112. The system 100 may include a television. The receptor 102, which may include a cable inlet or an antenna, may be adapted to receive signals, such as audio and video signals, from a provider. The provider may be a terrestrial broadcaster or a cable head-end. The tuner 104 may be adapted to facilitate selection of certain provider signals for presentation on the display 110 and over the speakers 112. The memory 108 may be adapted to hold machine-readable computer code that causes the processor 106 to perform an exemplary method in accordance with the present invention.

Media devices, such as system 100, are often adapted to transmit and receive video signals. For example, video signals received by system 100 may include data that designates rows of pixels in the display 110 for activation with assigned colors and brightness levels. By serially activating multiple horizontal rows along a vertical length of the display 110, a complete picture may be formed on the display 110. The data relating to the rows of pixels may be combined with synchronization signals (for example, horizontal sync and vertical sync signals) to provide the electronics within the system 100 with the information required to properly align and display the rows of pixels to present the desired picture. For example, the sync signal may indicate where on the screen 110 that the next row of pixels should be activated. Some media devices utilize embedded sync encoding. For example, embedded sync encoding may be utilized in video paths for uncompressed sources, such as a High-Definition Multimedia Interface, in some media devices.

In addition to video data, ancillary data types are often transmitted in television signals. For example, a television signal may include audio data and closed captioning data. Depending on which type of data is being transmitted, different components or features of a television may be utilized to interpret the data. Thus, it is often desirable to communicate what type of data is being transmitted. To achieve this, data headers are often used at the beginning of a data stream to indicate what type of data will follow the header. For example, a specific series of hexadecimal values may be utilized as a marker or header to indicate that a specific type of data, such as video data or closed captioning data, is being transmitted in a data packet following the header.

Certain values in a data system may be reserved for headers. For example, active video may be constrained to values 1 to 254 (01 h to FEh) in an 8 bit system because the values 0 and 255 (00h and FFh) are reserved as header values. These header values may be utilized as markers for two types of information, an embedded sync indicator and an ancillary data indicator. Specifically, an embedded sync marker may be composed of the bytes FFh 00h 00h xx, wherein “xx” is a changing value dependent upon what type (for example, vertical or horizontal) of sync is being indicated. Further, the start of ancillary data may be indicated by the bytes 00h FFh FFh, which may be followed by an ancillary data packet. For example, ancillary data packets may include audio samples or vertical blanking interval sliced data. The data packet generally appears in the horizontal or vertical blanking interval. It should be noted that the same reserved values (for example, 00h and FFh) are utilized for both types of information (for example, the embedded sync indicator and the ancillary data indicator). However, each type of information is distinguished because the sequence of the reserved values is reversed.

It has now been recognized that some media devices, such as video decoders, send and receive ancillary data packets that include embedded reserved values, such as 00h and FFh that can be improperly interpreted as headers. In most cases, great care is taken to ensure that data in an ancillary packet is constrained to appropriate values, such as values not reserved as header values. For example, ancillary data may be constrained to values 1 to 254 (01h to FEh) in an 8 bit system because the values 0 and 255 (00h and FFh) are reserved as header values. This constraint is placed on most ancillary data for various reasons. For example, the format of an ancillary data packet can be quite flexible (including the length of the data packet). Accordingly, without constraints, a receiving device may not be able to discern what data is ancillary and what is not.

Errors can occur when a value reserved as a header is included in a stream of data without being intended to act as a header. Indeed, such data can result in improper interpretation of the data and malfunction of a receiving media device. For example, a false header may indicate that ancillary data, such as audio data, should be interpreted as video data. In a specific example of empirical observation, an uncompressed video stream source (for example, a TI TVP5160 video decoder produced by Texas Instruments™) was found to have the series of values FFh 00h 00h inside an ancillary data packet. In fact, based on data captures, the series of values FFh 00h 00h was found to occur within twelve bytes of the ancillary data header (for example, within 12 cycles of the series 00h FFh FFh). This series of values within the ancillary data packet could be interpreted as an embedded sync header by a receiver (for example, a TI TVP9002 receiver produced by Texas Instruments™) that was being sent the video stream. However, it was merely erroneous data or a false header, not an actual sync header. Accordingly, the receiver could erroneously process the data that followed the false header within the ancillary packet as video data. This could cause the capture of the video stream to be incorrect, which could result in jerky and occasionally frozen video output. It should be noted that the false header could occur in a luminance portion of the video data, which is indicative of the brightness of the video.

FIG. 2 is a block diagram representing a system for detecting and correcting false headers in accordance with an exemplary embodiment of the present invention. The system is generally indicated by reference numeral 200. Specifically, FIG. 2 illustrates a video stream 202 being routed from a source 204, through a logic module 206, and into a receiver 208. The source 204 may include a video decoder, such as the TI TVP5160 video decoder produced by Texas Instruments™. The logic module may include a field programmable gate array (FPGA) on a system board of a media device, such as a television. The FPGA may be utilized to add video enhancements and may include some logic features. Further, the logic features, as discussed in detail below, may be configured to detect and replace false header data in the video stream 202. The receiver 208 may include the TI TVP9002 receiver produced by Texas Instruments™.

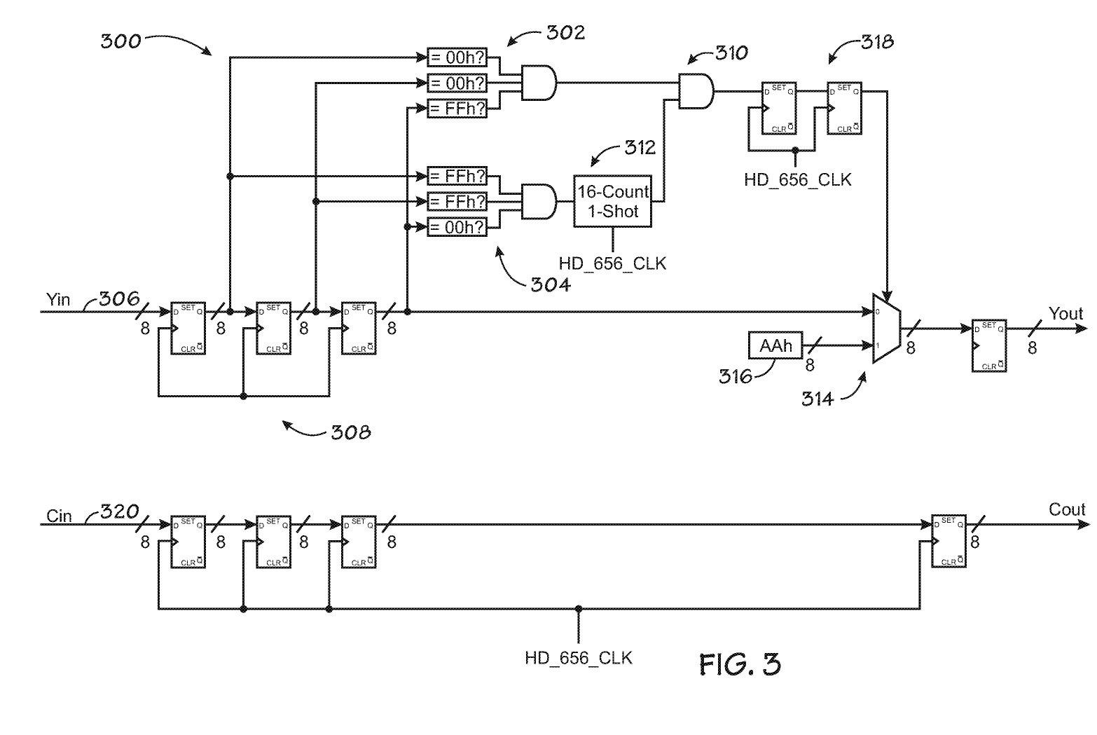

FIG. 3 is a block diagram of a logic circuit that is adapted to detect and correct false headers in data streams in accordance with an exemplary embodiment of the present invention. The logic circuit is generally indicated by reference numeral 300 and may be disposed, for example, within the logic module 206 (FIG. 2). According to logic circuit 300, when a series of values are determined to be a false header, all or a portion of the series of values are replaced by values that ensure that the series does not operate as a header. For example, in one embodiment, a false sync header may be detected and changed from FFh 00h 00h to FFh 00h AAh. In this example, the last hex value of the series is simply swapped with a different hex value (for example, AAh) that eliminates the significance of the series. Because the false header data essentially has no valid meaning, it can be changed to another meaningless value without causing the data stream to have problems.

The exemplary logic circuit 300 is illustrated with Boolean logic. The logic circuit 300 includes a first comparator circuit 302 and a second comparator circuit 304, wherein each comparator circuit is configured to detect a specific series of values in a luminance input data stream 306. The first and second comparator circuits 302 and 304 include AND gates that activate (e.g., output=1) their respective outputs when a specific set of values are found in a latch circuit or a memory 308. Specifically, for example, the first comparator circuit 302 may observe data from memory 308 and activate its output if the series FFh 00h 00h (for example, an embedded sync marker) is detected. The second comparator circuit 304 may observe data from the memory 308 and activate its output if the series 00h FFh FFh (for example, an ancillary data header) is detected. The outputs from both the first comparator circuit 302 and the second comparator circuit 304 are inputs to a false header AND gate 310, which may be utilized to determine whether a false header is present.

When the second comparator circuit 304 is activated, a one-shot clock 312 is activated for a designated amount of time or a window of time (for example, 12 or 16 cycles) to allow time to detect a false header. For example, the second comparator circuit 304 may detect the series 00h FFh FFh, which may be an ancillary data header indicating that an ancillary data packet will follow. Upon detecting this ancillary data header, the one-shot clock 312 may be activated for 16 cycles. Based on empirical data, a false header may be observed within twelve bytes of the ancillary data header, such as within 12 cycles of the series 00h FFh FFh. Accordingly, activating the one-shot clock 312 for 16 cycles will hold its output in an active state until time has been allowed to detect the false header. If the first comparator circuit 302 detects the series FFh 00h 00h within the designated time, such as 16 cycles, it is handled as a false header. Specifically, both inputs to the false header AND gate 310 will be activated, which will cause a multiplexer (MUX) 314 to replace data in the false header with different data stored in a data register 316 to prevent it from being recognized as a valid header. In the illustrated embodiment, the last value in the series, 00h, is replaced with AAh. However, in other embodiments, different values may be utilized. It should be noted that a synchronizing latch circuit 318 may be utilized after the false header AND gate 310 is activated to add delay. This delay may be desirable to keep a chrominance input data stream 320 synchronized with the luminance input data stream 306.

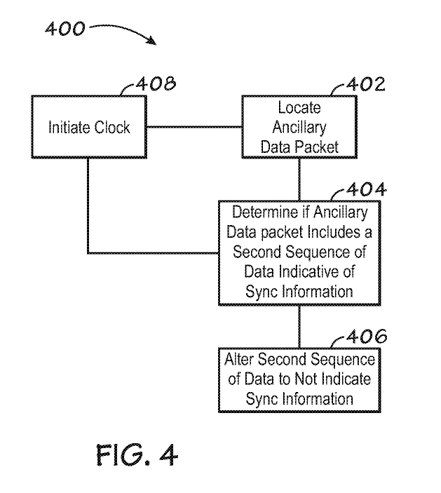

FIG. 4 is a process flow diagram illustrating a method in accordance with an exemplary embodiment of the present invention. The method illustrated in FIG. 4 is generally indicated by reference numeral 400. Method 400 comprises locating an ancillary data packet in a data stream based on a first sequence of data indicative of the ancillary data packet (402). The data stream may include a luminance data stream and may be received from a video decoder. The method 400 also includes determining if the ancillary data packet contains a second sequence of data indicative of sync information (404), and altering the second sequence of data to not indicate sync information if the ancillary data packet does contain the second sequence of data (406). In one embodiment, altering the second sequence of data in block 406 comprises replacing a reserved hexadecimal value in the second sequence with a non-reserved hexadecimal value (for example, replacing 00h with AAh). The method 400 also comprises initiating a clock (408) upon locating the ancillary data packet in the data stream based on the first sequence of data indicative of the ancillary data packet. This may provide a window of time, such as 12 or 16 cycles, for determining if the ancillary data packet contains the second sequence of data indicative of sync information (404).

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method, comprising:
locating an ancillary data packet in a data stream based on a first sequence of data indicative of the ancillary data packet;
determining if the ancillary data packet contains a second sequence of data indicative of sync information; and
altering the second sequence of data to not indicate sync information if the ancillary data packet does contain the second sequence of data.

2. The method of claim 1, comprising receiving the data stream from a video decoder.

3. The method of claim 1, wherein altering the second sequence of data comprises replacing a reserved hexadecimal value in the second sequence with a non-reserved hexadecimal value.

4. The method of claim 3, comprising replacing 00h with AAh.

5. The method of claim 1, comprising initiating a clock upon locating the ancillary data packet in the data stream based on the first sequence of data indicative of the ancillary data packet.

6. The method of claim 1, comprising providing a window of time for determining if the ancillary data packet contains the second sequence of data indicative of sync information.

7. The method of claim 6, wherein the window of time is defined by sixteen cycles.

8. The method of claim 1, wherein locating the ancillary data packet in the data stream comprises observing data values in a luminance data stream.

9. A method, comprising:
activating a first output if an ancillary data header is detected in a data stream, wherein the ancillary data header includes a first series of values that indicate an ancillary data packet will follow the ancillary data header;
activating a second output if a sync header is detected within the ancillary data packet, wherein the sync header includes a second series of values that indicate sync information; and
altering the second series of values to not indicate the sync information if the first and second outputs are activated.

10. The method of claim 9, comprising receiving the data stream from a video decoder.

11. The method of claim 9, wherein altering the second series of values comprises replacing a reserved hexadecimal value in the second series of values with a non-reserved hexadecimal value.

12. The method of claim 11, comprising replacing 00h with AAh.

13. The method of claim 9, comprising defining a window of time after detecting the ancillary data header in which detecting the sync header indicates that the sync header was detected within the ancillary data packet.

14. The method of claim 13, wherein the window of time is defined by twelve cycles.

15. The method of claim 13, wherein the window of time is defined by sixteen cycles.

16. A system, comprising:
a logic module, comprising:
a first comparator circuit configured to locate an ancillary data packet in a data stream based on a first sequence of data indicative of the ancillary data packet;
a second comparator circuit configured to determine if the ancillary data packet contains a second sequence of data indicative of sync information; and
a multiplexer configured to alter the second sequence of data to not indicate sync information if the ancillary data packet does contain the second sequence of data.

17. The system of claim 16, comprising a receiver configured to receive the data stream from the logic module.

18. The system of claim 16, comprising a video decoder configured to provide the data stream to the logic module.

19. The system of claim 16, wherein the multiplexer is configured to replace 00h with AAh in the second sequence of data.

20. The system of claim 16, comprising a clock module configured to facilitate determination of whether the second sequence of data is contained within the ancillary data packet.
